(19) United States
(12) Patent Application Publication
(10) Pub. No.: US 2003/0105626 A1
(43) Pub. Date: Jun. 5, 2003

(54) Method for improving speech quality in speech transmission tasks

(76) Inventors: Alexander Kyrill Fischer, Griesheim (DE); Christoph Erdmann, Aachen (DE)

Correspondence Address: DAVIDSON, DAVIDSON & KAPPEL, LLC, 485 SEVENTH AVENUE, 14TH FLOOR, NEW YORK, NY, 10018, US

(21) Appl. No.: 10/258,023

(22) PCT Filed: Mar. 8, 2001
(86) PCT No.: PCT/EP01/02603

(30) Foreign Application Priority Data
Apr. 28, 2000 (DE) 10020863.0

(51) Int. Cl. G10L 19/14

(52) U.S. Cl. 704/205

(57) ABSTRACT

A method for calculating the amplication factor, which co-determines the volume, for a speech signal transmitted in encoded form includes dividing the speech signal into short temporal signal segments. The individual signal segments are encoded and transmitted separately from each other, and the amplication factor for each signal segment is calculated, transmitted and used by the decoder to reconstruct the signal. The amplication factor is determined by minimizing the value E(g_opt2)=(1−a)*f₁(g_opt2)+a*f₂(g_opt2), the weighting factor a being determined taking into account both the periodicity and the stationarity of the encoded speech signal.

The present invention relates to a method according to the definition of the species in claim 1.

In the domain of speech transmission and in the field of digital signal and speech storage, the use of special digital coding methods for data compression purposes is widespread and mandatory because of the high data volume and the limited transmission capacities. A method which is particularly suitable for the transmission of speech is the Code Excited Linear Prediction (CELP) method which is known from U.S. Pat. No. 4,133,976. In this method, the speech signal is encoded and transmitted in small temporal segments (“speech frames”, “frames”, “temporal section”, “temporal segment”) having a length of about 5 ms to 50 ms each. Each of these temporal segments is not represented exactly but only by an approximation of the actual signal shape. In this context, the approximation describing the signal segment is essentially obtained from three components which are used to reconstruct the signal on the decoder side: Firstly, a filter approximately describing the spectral structure of the respective signal section; secondly, a so-called “excitation signal” which is filtered by this filter; and thirdly, an amplification factor (gain) by which the excitation signal is multiplied prior to filtering. The amplification factor is responsible for the loudness of the respective segment of the reconstructed signal.

The result of this filtering then represents the approximation of the signal portion to be transmitted. The information on the filter settings and the information on the excitation signal to be used and on the scaling (gain) thereof which describes the volume must be transmitted for each segment. Generally, these parameters are obtained from different code books which are available to the encoder and to the decoder in identical copies so that only the number of the most suitable code book entries has to be transmitted for reconstruction. Thus, when coding a speech signal, these most suitable code book entries are to be determined for each segment, searching all relevant code book entries in all relevant combinations, and selecting the entries which yield the smallest deviation from the original signal in terms of a useful distance measure.

There exist different methods for optimizing the structure of the code books (for example, multiple stages, linear prediction on the basis of the preceding values, specific distance measures, optimized search methods, etc.). Moreover, there are different methods describing the structure and the search method for determining the excitation vectors.

The amplification factor (gain value) can also be determined in different ways in a suitable manner. In principle, the amplification factor can be approximated using two methods which will be described below:

Method 1: “Waveform Matching”

In this method, the amplification factor is calculated while taking into account the waveform of the excitation signal from the code book. For the purpose of calculation, deviation E₁ between original signal x (represented as vector), i.e., the signal to be transmitted, and the reconstructed signal g H c is minimized. In this context, g is the amplification factor to be determined, H is the matrix describing the filter operation, and c is the most suitable excitation code book vector which is to be determined as well and has the same dimension as target vector x.

E₁=∥x−gHc∥²

Generally, for the purpose of calculation, optimum code book vector c-opt is determined first. After that, amplification factor g which is optimal for this is initially calculated and then, the matching code book vector g-opt is determined. This calculation yields good values every time that the waveform of the excitation code book vector from the code book, which vector is filtered with H, corresponds as far as possible to the input waveform. Generally, this is more frequently the case, for example, with clear speech without background noises than with speech signals including background noises. In the case of strong background noises, therefore, an amplification factor calculation according to method 1 can result in disturbing effects which can manifest themselves, for example, in the form of volume fluctuations.

Method 2: “Energy Matching”

In this method, amplification factor g is calculated without taking into account the waveform of the speech signal. Deviation E₂ is minimized in the calculation:

E₂=(∥exc(g)∥−∥res∥)²

In this context, exc is the scaled code book vector which depends on amplification factor g; res designates the “ideal” excitation signal. Moreover, other previously determined constant code book entries d may be added:

exc(g)=c_{—}opt*g+d

This method yields good values, for example, in the case of low-periodicity signals, which may include, for example, speech signals having a high level of background noise. In the case of low background noises, however, the amplification values calculated according to method 2 generally yield values worse than those of method 1.

In the method used today, initially, optimum code book entry g_opt resulting from method 1 is determined and then amplification factor g_opt2, which is quantized, i.e., found in the code book, and which is actually to be used, is determined by minimizing quantity E₃.

$${E}_{3} ( g\_opt2 ) = ( 1 - a ) * {‖ c - opt ‖}^{2} * {( g\_opt2 - g - opt )}^{2} + a * {( ‖ exg ( g\_opt2 ) ‖ - ‖ res ‖ )}^{2} \qquad Equation ( 1 )$$

In this context, weighting factor a can take values between 0 and 1 and is to be predetermined using suitable algorithms. For the extreme case that a=0, only the first summand is considered in this equation. In this case, the minimization of E₃ always leads to g_opt2=g_opt, so that value g_opt, which has previously been calculated according to method 1, is taken over as the result of the final amplification value calculation (pure “waveform matching”). In the other extreme case that a=1, however, only the second summand is considered. In this case, always the same solution then results for g_opt2 as when using method 2 (pure “energy matching”). The value of a will generally be between 0 and 1 and consequently lead to a result value for g_opt2 which takes into account both methods 1 “waveform matching” and 2 “energy matching”.

Thus, the degree to which the result of method 1 or the result of method 2 should. be used is controlled via weighting factor a. Quantized value gain-eff2, which is calculated according to equation (1) by minimizing E₃, is then transmitted and used on the decoder side.

The underlying problem now consists in determining weighting factor a for each signal segment to be encoded in such a manner that the most useful possible values are found through the calculation according to equation (1) or according to another minimization function in which a weighting between two methods is utilized. In terms of the speech quality of the transmission, “useful values” are values which are adapted as well as possible to the signal situation present in the current signal segment. For noise-free speech, for example, a would have to be selected to be near 0, in the case of strong background noises, a would have to be selected to be near 1.

In the methods used today, the value of weighting factor a is controlled via a periodicity measure by using the prediction gain as the basis for the determination of the periodicity of the present signal. The value of a to be used is determined via a fixed characteristic curve f(p) from the periodicity measure data describing the current signal state, the periodicity measure being denoted by p. This characteristic curve is designed in such a manner that it yields a low value for a for highly periodic signals. This means that for highly period signals, preference is given to method 1 of “waveform matching”. For signals of lower periodicity, however, a higher value is selected for a, i.e., closer to 1, via f(p).

In practice, however, it has turned out that this method still results in artifacts in the case of certain signals. These include, for example, the beginning of voiced signal portions, so-called “onsets”, or also noise signals without periodic components.

Therefore, the object of the present invention is to provide a method which allows an optimum weighting factor a to be determined for the calculation of as optimum as possible an amplification factor for nearly all signals.

This objective is achieved according to the present invention by the features of claim 1. Further advantageous embodiments of the method follow from the features of the subclaims.

In the method according to the present invention, provision is made to not only use periodicity S₁ of the signal but to also use stationarity S₂ of the signal for determining the weighting factor. Depending on the quality of weighting factor a to be determined, it is possible for further parameters which are characteristic of the present signals, such as the continuous estimation of the noise level, to be taken into account in the determination of the weighting factor. Therefore, weighting factor a is advantageously determined not only from periodicity S₁ but from a plurality of parameters. The number of used parameters or measures will be denoted by N. An improved, more robust determination of a can be accomplished by combining the results of the individual measures. Thus, the value of a to be used is no longer made dependent on one measure only but, via a rule h, it depends on the data of all N measures S₁ , S₂, . . . S_{N} describing the current signal state. The resulting relationship is shown in equation (2):

a=h(^{S}₁ , S₂, . . . S_{N}) (equation 2)

Thus, an exemplary implementation according to the present invention could be considered to consist in a system which, on one hand, uses a periodicity measure S₁ and, in addition, also a stationarity measure S₂. By additionally taking into account stationarity measure S₂ of the signal, it is possible to better deal, for example, with the problematic cases (onsets, noise) mentioned above. In this context, in a speech coding system using the method according to the present invention, initially, the results of periodicity measure S₁ and of stationarity measure S₂ are calculated. Then, the suitable value for weighting factor a is calculated from the two measures according to equation (2). This value is then used in equation (1) to determine the best value for the amplification factor.

A concrete way of implementing the assignment rule h(S₁) is, for example, to use a number K of different characteristic curve shapes h₁(S₁) . . . hₖ(S₁ ) and to control, via a parameter S₂, characteristic curve shape hᵢ(S₁) which is to be used in the present signal case.

In this context, the following distinctions could be made for K=3:

use a=h₁(S₁), if S₂ₐ<S₂<=S_{2b},

use a=h₂(S₁), if S_{2b}<S₂<=S_{2c},

use a=h₃(S₁), if S_{2c}<S₂<=S_{2d},

where S₂ₐ<S₂<S_{2d}

In the following, the method according to the present invention will be explained in greater detail with the example that K=2. In this case, the used assignment rule h(.) provides for two different characteristic curve shapes h₁(S₁) and h₂(S₁). The respective characteristic curve is selected as a function of a further parameter S₂ which is either 0 or 1.

Parameter S1 describes the voicedness (periodicity) of the signal. The information on the voicedness results from the knowledge of input signal s(n) (n=0 . . . L, L: length of the observed signal segment) and of the estimate t of the pitch (duration of the fundamental period of the momentary speech segment). Initially, a voiced/unvoiced criterion is to be calculated as follows:

$$χ = \frac{{\sum }_{i = 0}^{L - 1} s ( i ) \cdot s ( i - τ )}{\sqrt{{\sum }_{i = 0 }^{L - 1 } {s}^{2} ( i ) \cdot {\sum }_{i = 0}^{L - 1} {s}^{2} ( i - τ )}}$$

The parameter S1 used is now obtained by generating the short-term average value of χ over the last 10 signal segments (m_{cur}: index of the current signal segment):

$${S}_{1} = \frac{1}{10} {\sum }_{i = {m}_{cur} - 10}^{{m}_{cur}} {χ}_{i} .$$

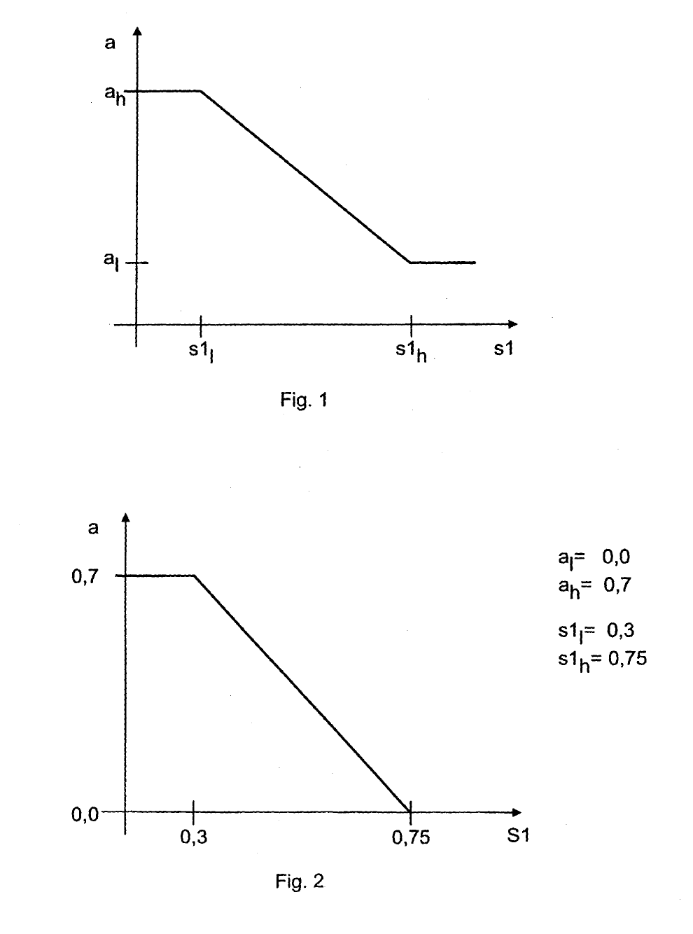

FIG. 1 is a schematic representation of the dependence of weighting factor a on S₁.

Accordingly, the shape of the characteristic curve depends on the selection of threshold values a₁ and aₕ as well as s1₁ and s1ₕ.

The indicated selection of characteristic curve h₁ or h₂ as a function of S₂ means that different combinations of threshold values (a₁, aₕ, s1₁, s1ₕ) are selected for different values of S₂.

Parameter S₂ contains information on the stationarity of the present signal segment. Specifically, this is status information which indicates whether speech activity (s2=1) or a speech pause (S₂=0) is present in the signal segment currently observed. This information must be supplied by an algorithm for detecting speech pauses (VAD=Voice Activity Detection).

Since the recognition of speech pauses and of stationary signal segments are in principle similar, the VAD is not optimized for an exact determination of the speech pauses (as is otherwise usual) but for a classification of signal segments that are considered to be stationary with regard to the determination of the amplification factor.

Since stationarity S₂ of a signal is not a clearly defined measurable variable, it will be defined more precisely below.

If, initially, the frequency spectrum of a signal segment is looked at, it has a characteristic shape for the observed period of time. If the change in the frequency spectra of temporally successive signal segments is sufficiently low, i.e., the characteristic shapes of the respective spectra are more or less maintained, then one can speak of spectral stationarity.

If a signal segment is observed in the time domain, then it has an amplitude or energy profile which is characteristic of the observed period of time. If the energy of temporally successive signal segments remains constant or if the deviation of the energy is limited to a sufficiently small tolerance interval, then one can speak of temporal stationarity.

If temporally successive signal segments are both spectrally and temporally stationary, then they are generally described as stationary. The determination of spectral and temporal stationarity is carried out in two separate stages. Initially, the spectral stationarity is analyzed:

Spectral Stationarity (Stage 1)

To determine whether spectral stationarity exists, initially, a spectral distance measure), the so-called “spectral distortion” SD, of successive signal segments is observed. The resulting calculation is as follows:

$$SD = \sqrt{\frac{1}{2 π} {\int }_{- π}^{π} {( 10 log [ \frac{1}{{\vert A ( {ⅇ}^{jω} ) \vert}^{2}} ] - 10 log [ \frac{1}{{\vert {A}^{′} ( {ⅇ}^{jω} ) \vert}^{2}} ] )}^{2} ⅆ ω}$$

In this context,

$$10 log [ \frac{1}{{\vert A ( {ⅇ}^{jω} ) \vert}^{2}} ]$$

denotes the logarithmized frequency response envelope of the current signal segment, and

$$10 log [ \frac{1}{{\vert {A}^{′} ( {ⅇ}^{jω} ) \vert}^{2}} ]$$

denotes the logarithmized frequency response envelope of the preceding signal segment. To make the decision, both SD itself and its short-term average value over the last 10 signal segments are looked at. If both measures SD and are below a threshold value SD_{g}, and _{g}, respectively, which are specific for them, then spectral stationarity is assumed.

Specifically, it applies that SD_{g}=2.6 dB

\overline{SD_{g}}=2.6 dB

It is problematic that extremely periodic (voiced) signal segments feature this spectral stationarity as well. They are excluded via periodicity measure s1. It applies that:

If s1≧0.7

or s1<0.3

the observed signal segment is assumed not to be spectrally stationary.

Temporal Stationarity (Stage 2):

The determination of temporal stationarity takes place in a second stage whose decision thresholds depend on the detection of spectrally stationary signal segments of the first stage. If the present signal segment has been classified as spectrally stationary by the first stage, then its frequency response envelope

$$\frac{1}{{\vert A ( {ⅇ}^{jω} ) \vert}^{2}}$$

is stored. Also stored is reference energy E_{reference} of residual signal d_{reference} which results from the filtering of the present signal segment with a filter having the frequency response |A(e^{jω})|² which is inverse to this signal segment. E_{reference} results from

$${E}_{reference} = {\sum }_{n = 0}^{L - 1} {d}_{reference}^{2} ( n )$$

where L corresponds to the length of the observed signal segment.

This energy serves as a reference value until the next spectrally stationary segment is detected. All subsequent signal segments are now filtered with the same stored filter. Now, energy Eᵣₑₛₜ of residual signal dᵣₑₛₜ which has resulted after the filtering is measured. Accordingly, it is expressed as:

$${E}_{rest} = {\sum }_{n = 0}^{L - 1} {d}_{rest}^{2} ( n ) .$$

The final decision of whether the observed signal segment is stationary follows the following rule:

If: Eᵣₑₛₜ<E_{reference}+tolerance

s2=1, signal stationary,

otherwise s=0, signal non-stationary

By way of example, the assignment depicted in FIG. 2 applies in this context, where for

s2=1 (h1(s1), non-stationary): and

s2=0 (h2(s1), stationary/pause)→a=1.0 for all s1

This means that the characteristic curve is flat and that a has the value 1, independently of s1.

It is, of course, also possible to conceive of a dependency in which a continuous parameter S₂ (0≦s2≦1) contains information on stationarity S₂. In this case, the different characteristic curves h₁ and h₂ are replaced with a three-dimensional area h(s1, s2) which determines a.

It goes without saying that the algorithms for determining the stationarity and the periodicity must or can be adapted to the specific given circumstances accordingly. The individual threshold values and functions mentioned above are only exemplary and generally have to be found by separate trials.

What is claimed is:

1. A method for calculating the amplification factor which co-determines the volume for a speech signal transmitted in encoded form, the speech signal being divided into short temporal signal segments, and the individual signal segments being encoded and transmitted separately from each other, and the amplification factor for each signal segment being calculated, transmitted and used by the decoder to reconstruct the signal, the amplification factor being determined by minimizing the quantity E(g_opt2)=(1−a)* f₁(g_opt2)+a*f₂(g_opt2),
wherein the weighting factor a is determined while taking account of both the stationarity and the periodicity of the encoded speech signal.

2. The method as recited in claim 1,
wherein the quantity E(g_opt2) is minimized using the equation:
$$E ( g\_opt2 ) = ( 1 - a ) * {‖ c - opt ‖}^{2} * {( g\_opt2 - g\_opt )}^{2} + a * {( ‖ exc ( g\_opt2 ) ‖ - ‖ res ‖ )}^{2} .$$

3. The method as recited in claim 1 or 2,
wherein a specific function hᵢ(S₁) for determining the weighting factor a is selected as a function of the value determined for the stationarity S₂ of the speech signal, with S₁ being a measure for the periodicity of the speech signal.

4. The method as recited in claim 3,
wherein the stationarity S₂ is a measure or essentially is a measure for the speech activity.

5. The method as recited in one of the claims 3 or 4,
wherein the stationarity S₂ is a measure for the ratio of speech level to background noise level of the signal segment to be observed.

6. The method as recited in one of the preceding claims,
wherein the stationarity S₂ is calculated as a function of the spectral change and of the energy change (temporal stationarity).

7. The method as recited in claim 6,
wherein for calculating the spectral stationarity and the energy change (temporal stationarity) at least one temporally preceding signal segment is taken into account.

8. The method as recited in claim 7,
wherein the determined values of the spectral change influence the assessment of the energy change or temporal stationarity.
